(19) United States
(12) Patent Application Publication
(10) Pub. No.: US 2025/0372127 A1
(43) Pub. Date: Dec. 4, 2025

(54) CONTENT GENERATION

(71) Applicant: Beijing Zitiao Network Technology Co., Ltd., Beijing (CN)

(72) Inventors: Lingxuan Shen, Beijing (CN); Xiu Pei, Beijing (CN)

(21) Appl. No.: 19/222,459

(22) Filed: May 29, 2025

(30) Foreign Application Priority Data
May 30, 2024 (CN) 202410693952.X

(51) Int. Cl. G11B 27/036

(52) U.S. Cl. CPC G11B 27/036

(57) ABSTRACT

According to embodiments of the disclosure, a method, an apparatus, a device and a storage medium for content generation are provided. The method includes: in response to an audio edit request, presenting an audio edit panel comprising at least an audio generating control; in response to detecting a trigger on the audio generating control, obtaining a first text and a first audio corresponding to the first text, at least one of the first text or the first audio being determined based on a content entity to be edited; and adding the first text and the first audio into the content entity to obtain a first video, wherein the first text is presented overlapped on the content entity, and the first audio is configured to be at least a part of an audio corresponding to the first video.

### CROSS-REFERENCE

The present application claims priority to Chinese Patent Application No. 202410693952.X, filed on May 30, 2024 and entitled “METHOD, APPARATUS, DEVICE AND STORAGE MEDIUM FOR CONTENT GENERARTION”, the entirety of which is incorporated herein by reference.

### FIELD

Example embodiments of the present disclosure generally relate to the field of computer, and in particular, to content generation.

### BACKGROUND

Currently, more and more applications are designed to provide various services to users. Many applications may support users for message interaction. During a process of information interaction by people through the Internet, various types of audio have become an important medium for people to socially express and exchange information. Thus, an interesting audio play is expected to meet user requirements.

### SUMMARY

In a first aspect of the present disclosure, a method for content generation is provided. The method comprises: in response to an audio edit request, presenting an audio edit panel comprising at least an audio generating control; in response to detecting a trigger on the audio generating control, obtaining a first text and a first audio corresponding to the first text, at least one of the first text or the first audio being determined based on a content entity to be edited; and adding the first text and the first audio into the content entity to obtain a first video, wherein the first text is presented overlapped on the content entity, and the first audio is configured to be at least a part of an audio corresponding to the first video.

In a second aspect of the present disclosure, an apparatus for content generation is provided. The apparatus comprises: an edit panel presenting module configured to in response to an audio edit request, present an audio edit panel comprising at least an audio generating control; a text and audio obtaining module configured to in response to detecting a trigger on the audio generating control, obtain a first text and a first audio corresponding to the first text, at least one of the first text or the first audio being determined based on a content entity to be edited; and a video obtaining module configured to add the first text and the first audio into the content entity to obtain a first video, wherein the first text is presented overlapped on the content entity, and the first audio is configured to be at least a part of an audio corresponding to the first video.

In a third aspect of the present disclosure, an electronic device is provided. The device comprises at least one processing unit; and at least one memory, the at least one memory being coupled to the at least one processing unit and storing instructions for execution by the at least one processing unit. When executed by the at least one processing unit, the instructions cause the electronic device to perform the method of the first aspect.

In a fourth aspect of the present disclosure, a computer-readable storage medium is provided. The computer-readable storage medium has a computer program stored thereon, and the computer program is executable by the processor to implement the method of the first aspect.

In a fifth aspect of the present disclosure, a computer program product is provided. The computer program product is tangibly stored in a computer storage medium and comprises computer-executable instructions which, when executed by a device, cause the device to perform the method of the first aspect.

It should be understood that the content described in this content section is not intended to limit the key features or important features of embodiments of the present disclosure, nor is it intended to limit the scope of the present disclosure. Other features of the present disclosure will become easy to understood from the following description.

### BRIEF DESCRIPTION OF DRAWINGS

The above and other features, advantages and aspects of the various embodiments of the present disclosure will become more apparent in combination with the accompanying drawings and with reference to the following detailed description. In the accompanying drawings, the same or similar reference symbols refer to the same or similar elements, wherein:

FIG. 1 illustrates a schematic diagram of an example environment in which embodiments of the present disclosure can be implemented;

FIGS. 2A-2F illustrate schematic diagrams of example interfaces for content generation according to some embodiments of the present disclosure;

FIG. 3 illustrates a flowchart of a process for content generation according to some embodiments of the present disclosure;

FIG. 4 illustrates a block diagram of an apparatus for content generation according to some embodiments of the present disclosure; and

FIG. 5 illustrates a block diagram of a device capable of implementing various embodiments of the present disclosure.

### DETAILED DESCRIPTION

It can be understood that, before the technical solutions disclosed in the embodiments of the present disclosure are used, the types, the usage scope, the usage scenario of personal information involved in the present disclosure, and the like should be notified to the user to obtain the authorization of the user in an appropriate manner according to the relevant laws and regulations.

For example, in response to receiving an active request from a user, a prompt message is sent to the user to explicitly prompt the user that the operation requested operation by the user will need to obtain and use the user's personal information, so that users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

It may be understood that the data involved in the technical solution (including but not limited to the data itself, the acquisition or use of the data) should follow the requirements of the corresponding laws and regulations and related rules.

Embodiments of the present disclosure will be described in more detail below with reference to the accompanying drawings. Although certain embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

It should be noted that the title of any section/subsection provided herein is not limited. Various embodiments are described throughout and any type of embodiments may be included in any section/subsection. Furthermore, embodiments described in any one section/subsection may be combined in any manner with any other embodiments described in the same section/subsection and/or different sections/subsections.

Unless explicitly stated herein, performing a step “in response to A” does not mean that this step is performed immediately after “A”, but may include one or more intermediate steps.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. The terms “first,” “second,” and the like may refer to different or identical objects. Other explicit and implicit definitions may also be included below.

As used herein, the term “model” can learn an association between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. As used herein, “model” may also be referred to as “machine learning model”, “machine learning network”, or “network”, and these terms are used interchangeably herein. A model may also include different types of processing units or networks.

As used herein, a “unit,” an “operating unit,” or a “subunit” may be composed of a machine learning model or network of any suitable structure. As used herein, a set of elements or similar expressions may include one or more such elements. For example, a “set of convolution units” may include one or more convolution units.

The term “work” of the present disclosure refers to any type of media content or media works, which includes one or more types of content, including but not limited to, an audio file, a video file, a picture file, a text file, and the like. Specifically, the work may be a short video, a music, a picture, a picture compilation, a multimedia clip, an audio data, and the like. The present disclosure is not limited in this respect.

As briefly described above, in the process of people performing information interaction through the Internet, various types of audio have become an important medium for people to socially express and exchange information. Currently, audio and music, or some audio with a music type may be generated by a music generator. However, the technology of the music generator itself is limited, and the link is long and complex, resulting in poor conversion to audio.

Embodiments of the present disclosure provide a solution for content generation. According to various embodiments of the present disclosure, if the user initiates an audio edit request, then the terminal device of the user presents an audio edit panel including at least an audio generating control. If the user clicks the audio generating control, the terminal device obtains the first text and the first audio corresponding to the first text based on the trigger of the user. At least one of the first text and the first audio is determined based on a content entity to be edited. Then, the terminal device adds the first text and the first audio to the content entity, to further obtain the first video, where the first text is presented overlapped on the content entity, and the first audio is configured to be at least a part of the audio corresponding to the first video.

Therefore, without user input, and based on the understanding of the content entity, the video formed by the text and the audio corresponding to the text can be generated, thereby providing a lightweight, interesting, and personalized audio playing manner for the user, and the contribution rate draft rate of the user on the platform is promoted.

### Example Environment

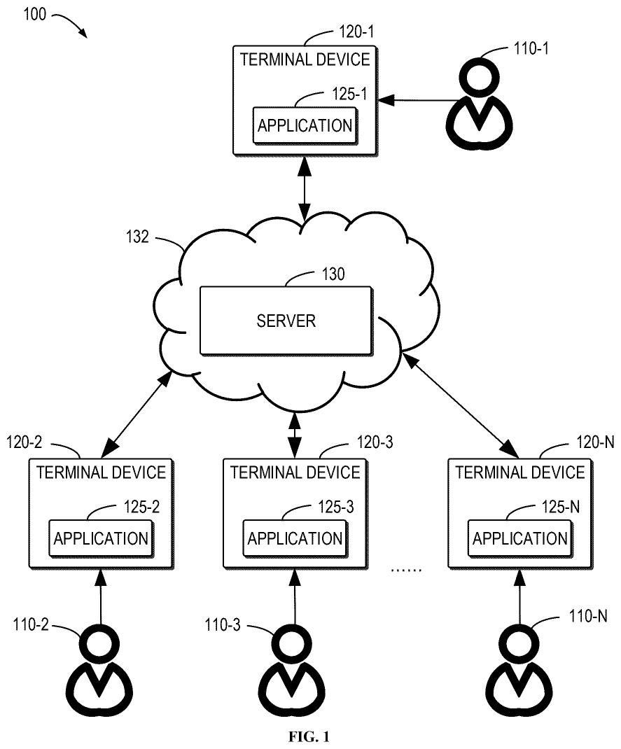

FIG. 1 illustrates a schematic diagram of an example environment 100 in which embodiments of the present disclosure can be implemented. The environment 100 including one or more users 110-1, 110-2, 110-3, . . . , 110-N may achieve the transmitting and receiving of message by terminal device 120-1, 120-2, 120-3, . . . , 120-N associated with each of them. For ease of discussion, users 110-1, 110-2, 110-3, . . . , 110-N may be referred to user 110 in combination or separately, and terminal device 120-1, 120-2, 120-3, . . . , 120-N may be referred to terminal device 120 in combination or separately. In some scenarios, the user 110 may publish and comment the work in the target platform by an associated terminal device 120. In some scenarios, user 110 is also referred to as a publisher of a work.

An application 125 supporting message interaction may be installed in the terminal device 120 (that is, an application 125-1 is installed in the terminal device 120-1, an application 125-2 is installed in the terminal device 120-2, an application 125-3 is installed in the terminal device 120-3, . . . , and an application 125-N is installed in the terminal device 120-N). It should be noted that the applications 125 installed in different terminal devices 120 may be the same application or different applications (for example, different versions). The application 125 may be any suitable application having a function of transmitting and receiving message, for example, may be a dedicated chat application, a social application, a content sharing application, an office support application, and the like.

In environment 100 of FIG. 1, if application 125 is active, terminal device 120 may present a user interface of application 125. The user interface may include various interfaces that may be provided by the application 125, such as a user interface that supports message interaction, a user interface that supports content browsing, an interface of transmitting and receiving message, and the like. Via different user interfaces, the application 125 may provide different content to the user 110. Via appropriate means, such as clicking or selecting any appropriate element in the user interface, the application 125 may also provide the user 110 with the selection and switching of the presentation manner of the associated content.

In some embodiments, different terminal devices 120 may also communicate with the server 130 through the network 132, to achieve the supply of the message interaction service. The server 130 may provide functions such as management, configuration, and maintenance of the application 125.

The terminal device 120 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a television receiver, a radio broadcast receiver, an electronic book device, a gaming device, or any combination of the foregoing, including accessories and peripherals of these devices, or any combination thereof. In some embodiments, the terminal device 120 may also support any type of interface for a user (such as a “wearable” circuit, etc.). The server 130 may be various types of computing systems/servers capable of providing computing power, including, but not limited to, mainframes, edge computing nodes, computing devices in a cloud environment, and the like.

It should be understood that the structure and function of the environment 100 is described only for purposes of an example, and does not imply any limitation to the scope of the present disclosure.

Some example embodiments of the present disclosure will be described below with reference to the accompanying drawings. It should be understood that the pages shown in the drawings are merely examples, and various page designs may actually exist. Various graphical elements in a page may have different arrangements and different visual representations, one or more of which may be omitted or replaced, and one or more other elements may also exist. Embodiments of the present disclosure are not limited in this respect.

In the following, an example embodiment will be described mainly from the perspective of the terminal device 120. It should be understood that the actions described with respect to the terminal device 120 may be performed by an application on the terminal device 120, and/or may be performed by an application in cooperation with a server side (for example, a server) of the terminal device 120.

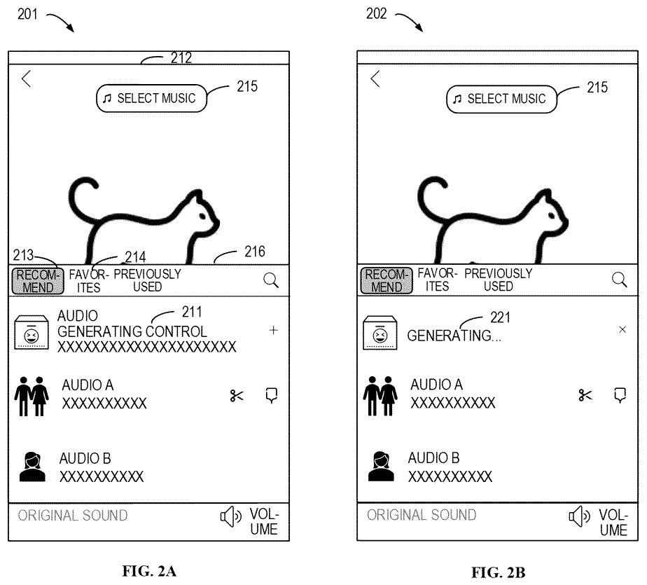

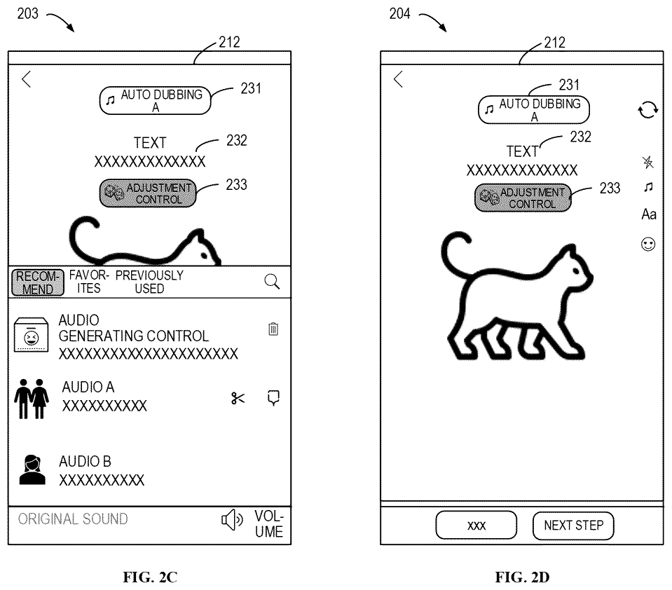

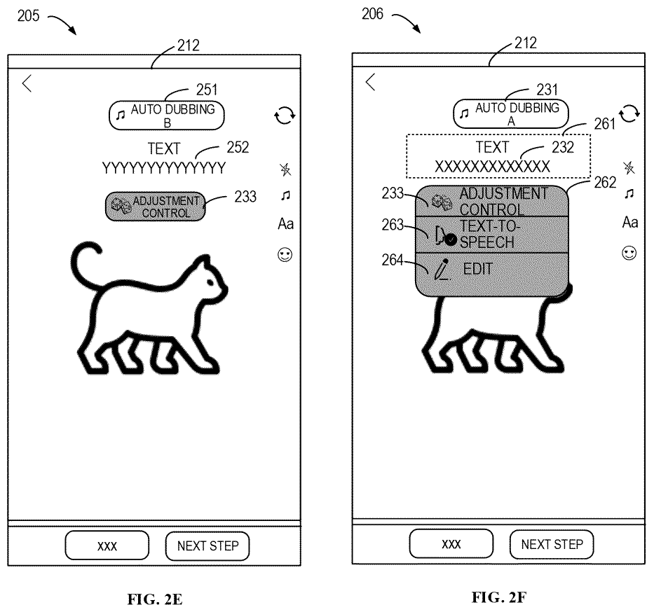

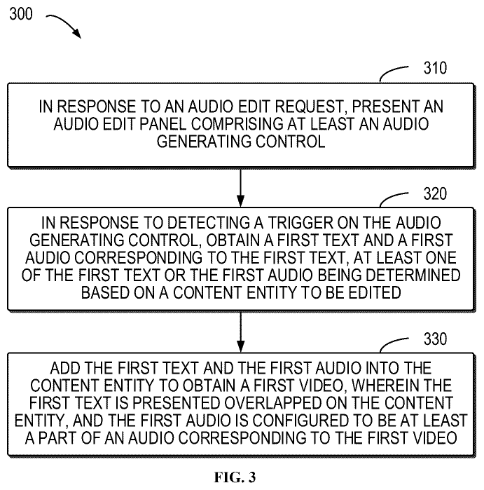

Solutions of the present disclosure for content generation are described below with reference to FIGS. 2A-2F. FIG. 2A to FIG. 2F are schematic diagrams of example interfaces 201 to 206 for performing content generation according to some embodiments of the present disclosure.

In some embodiments, if an audio edit request is received by the terminal device 120, an audio edit panel including at least an audio generating control is presented. An audio edit request is, for example, a request initiated when a user is expected to publish or edit a work. In some examples, in a scenario in which the user 110 starts to edit or publish a work, the terminal device 120 presents an audio edit panel including at least an audio generating control if a trigger operation of the user 110 for the control corresponding to the “select music” is received.

In some other examples, in a scenario in which the user 110 starts to edit or publish a work for the to-be-edited content entity, the terminal device 120 presents an audio edit panel including at least a content entity and an audio generating control if a trigger operation of the user 110 for the control corresponding to the “select music” is received. As shown in the example interface 201 shown in FIG. 2A, after the terminal device 120 receiving the audio edit request (for example, the user 110 clicks the control 215 corresponding to the “select music”), the audio edit panel 216 including at least the content entity 212 to be edited and the audio generating control 211 is presented. In some examples, the content entity 212 to be edited may be used to indicate content (e.g., video and/or pictures, collections of pictures) included in the video and/or picture.

In some examples, the audio generating control 211 may be presented by the terminal device 120 under the “recommend” list 213 included in the audio edit panel 216. Alternatively, the audio generating control 211 may also be presented by the terminal device 120 in other lists included in the audio edit panel 216 (e.g., presented in the “favorites” list 214), which is only an example shown in FIG. 2A.

In some embodiments, the terminal device 120 randomly selects the visual style of the audio generating control from the plurality of candidate visual styles in one or more presentation of the audio edit panel. In some examples, the visual style of the presented audio generating control 211 is randomly selected from the plurality of candidate visual styles each time the audio edit panel is presented. It may be understood that, in a process of presenting or loading an audio edit panel each time, the terminal device 120 randomly presents different animation designs of the audio generating control 211.

In some embodiments, if the terminal device 120 detects a trigger operation on the audio generating control, the first text and the first audio corresponding to the first text are obtained. In some embodiments, the terminal device 120 determines the first text and the first audio based on the to-be-edited content entity. As shown in the example interfaces 201 to 203 in FIG. 2A to FIG. 2C, if detecting the trigger operation of the user 110 on the audio generating control 211, the terminal device 120 determines the text 232 (for example, the text XXXXX) and the auto dubbing A 231 corresponding to the text 232 according to the content entity 212 to be edited, as shown in FIG. 2C. In some examples, after the user 110 clicks the audio generating control 211, as shown in the interface 202 of FIG. 2B, the terminal device 120 may present the prompt information 221 (for example, “generating”) in the region corresponding to the audio generating control 211, to notify the user 110 that it is currently in the audio generation process.

In some embodiments, after detecting the trigger of the user on the audio generating control 211, an audio generation request is sent to the server (for example, the server 130), and the audio generation request may include the current content entity 212 or description information for the content entity 212. The server generates the first text based on the content entity by invoking a machine learning model. The machine learning model used to generate the text may be a generative model implemented based on a language model. The input of the machine learning model may be a prompt word and a content entity 212 (or description information of the content entity 212), and the output may be the first text. The first text may be text having a particular style suitable for being added to the content entity. After obtaining the first text, the server may further invoke a text to speech (TTS) model to generate the first audio (speech) corresponding to the first text. In some embodiments, the invoking of the model may be performed locally at the terminal device. The terminal device 120 may invoke the machine learning model to generate the first text, and invoke the TTS model to generate the first audio.

In some embodiments, after obtaining the first text and the first audio, the terminal device 120 adds the first text and the first audio to the content entity to obtain the first video. In some embodiments, the terminal device 120 may present the first text overlapped on the content entity, and the first audio is configured to be at least a part of the audio corresponding to the first video.

As shown in the example interfaces 203 to 204 in FIG. 2C to FIG. 2D, after the terminal device 120 obtains the text 232 and the auto dubbing A231 converted by the text 232, the terminal device 120 adds the text 232 and the auto dubbing A231 to the content entity 212 to form a video. That is, the terminal device 120 presents the text 232 on the content entity 212, and the auto dubbing A231 is configured to be a part of the audio corresponding to the video. In some examples, if the content entity 212 is a static image or a set of images, a piece of video is to be obtained after adding the auto dubbing A231. If the content entity 212 is a video, it is still a video after adding the auto dubbing A231.

In some embodiments, the terminal device 120 may obtain the first text using the following manners: the terminal device 120 samples a part of content from the content entity, and extracts, according to the part of content obtained by sampling, first semantic information corresponding to the part of content using a semantic model. Then, the terminal device 120 generates the first text according to the first semantic information and prompt information, using a machine learning model. In some examples, when the content entity 212 is a video, the terminal device 120 samples a plurality of frames by extracting frames. When the content entity 212 is an image, the terminal device 120 samples a partial image region of the image.

For example, in case of the content entity 212 being a video, the terminal device 120 performs frame extraction on the video to obtain a partial frame of the video. Then, the terminal device 120 extracts the semantic information of the partial frame of the video by using the semantic model. Then, the terminal device 120 may understand the video by using a machine learning model according to the semantic information and the prompt information, and generate, based on the video, a new text which is fun and meets user expectations. It may be understood that the terminal device 120 samples partial content from the content entity 212, which may avoid non-compliance use of the information at the remote end, which ensures data security.

In some embodiments, the first timbre type of the first audio is generated based on the content entity using a machine learning model. In some examples, the machine learning model may run remotely, e.g., at a server side, or may run locally, such as at a terminal device. Correspondingly, the first audio may be generated by performing text-to-speech on the first text based on the first timbre type. In some examples, the timbre type corresponding to the audio of the reading text 232 may also be generated according to the content entity using a machine learning model.

In some embodiments, the terminal device 120 may determine the timbre type specified by the user as the first timbre type. Before the text and audio are created, a candidate timbre type may be provided to the user and the user's selection is received. For example, the terminal device 120 may determine the timbre type A selected by the user to be the timbre type of the reading text 232, and generate the auto dubbing A231 having the timbre type A by the TTS function. In this process, the text 232 is still automatically generated by the machine learning model, while the timbre type of the audio may be selected by the user.

In some embodiments, one timbre type may also be randomly selected from the timbre library to be the first timbre type. For example, each time when the text is generated by the machine learning model, the timbre type B may be randomly selected from the timbre library to be determined as the timbre type of the reading text 232. The auto dubbing A231 with the timbre type B then may be generated by the TTS function. It should be understood that the timbre or the target timbre for the user to select in the present disclosure is an existing timbre authorized to be used existing in the sound library.

In conclusion, in the case that the user may not find the audio that fits the content entity, the terminal device 120 can generate the audio which fits the content entity according to the content entity by using the machine learning model or a manner of randomly selecting a timbre from the timbre library.

In some embodiments, the text style of the first text is determined by the machine learning model based on the content entity. The terminal device 120 determines the text style of the text 232 according to the content entity by using a machine learning model. For example, if the machine learning model determines that the content entity is a lively style, then the terminal device 120 finally determines that the text style of the text 232 is a lively style. If the machine learning model determines that the content entity is a heavy style, then the terminal device 120 finally determines that the text style of the text 232 is a strict style. In some embodiments, the first timbre type of the first audio is determined based on the content entity by the machine learning model. The timbre type may indicate a timbre matching with the content entity and/or matching with the first text.

The foregoing describes that the terminal device generates and applies the text and the audio corresponding to the text to the video in response to the user triggering the audio generating control. Adjusting the text and the audio corresponding to the text is described below with continued reference to FIGS. 2D-2F.

In some embodiments, the terminal device 120 may further present an adjustment control in association with the first video. The adjustment control is configured to adjust the first text and the first audio in the target content. If the terminal device 120 detects the trigger operation on the adjustment control, the terminal device 120 obtains the second text and the second audio for replacing the first text and the first audio. The terminal device 120 may determine the second text and the second audio based on the content entity. Then, the terminal device 120 adds the second text and the second audio to the content entity to obtain the second video. The terminal device 120 presents the second text overlapped on the content entity, and configures the second audio to be at least a part of the audio corresponding to the second video.

As shown in the example interfaces 204 to 205 in FIGS. 2D-2E, the terminal device 120 may also present the adjustment control 233 in association with the first video for the user 110 to adjust the text 232 and the auto dubbing A231. If the terminal device 120 detects that the user 110 clicks the adjustment control 233, then it obtains the text 252 (for example, the text YYYYY) determined again and the auto dubbing B251 corresponding to the text 252 according to the content entity. Subsequently, the terminal device 120 replaces the text 232 in the first video with the text 252, and replaces the auto dubbing A231 in the first video with the auto dubbing B251 to form the second video. In some examples, the text 252 is present overlapped in the content entity 212.

In some examples, if the terminal device 120 detects the trigger on the adjustment control 233, the text in the first video may be adjusted to another text. If the terminal device 120 detects the trigger on the adjustment control 233, the timbre of the audio in the first video may be randomly adjusted to another timbre.

In some embodiments, if the terminal device 120 detects a trigger on the adjustment control, then it presents the text style selection entry and/or the timbre selection. The terminal device 120 receives the selection of the second text style via the text style selection entry, and/or receives the selection of the second timbre type via the timbre selection entry. The terminal device 120 then obtains a second text with a second text style and a second audio with a second timbre type for replacing the first text and the first audio, respectively.

In some examples, if the terminal device 120 detects the trigger on the adjustment control, the terminal device 120 presents the text style selection entry and/or the timbre selection entry. The terminal device 120 presents the text style list if it detects that the user 110 clicks the text style selection entry. The terminal device 120 presents the timbre list if it detects that the user 110 clicks the timbre selection entry. For example, if the user 110 selects the text style X from the text style list, the terminal device 120 obtains the text with the text style X based on the text style entry. The terminal device 120 reads the text having the text style X with the first timbre to form the second audio. Then, the terminal device 120 adds the second audio and the text having the style X to the content entity to generate the second video.

As another example, if the user 110 selects the timbre Y from the timbre list, the terminal device 120 obtains the second audio with the timbre Y based on the timbre selection entry. The terminal device 120 reads the first text (for example, the text 232) with the timbre having the timbre Y to form the second audio. Then, the terminal device 120 adds the second audio and the text with the style X to the content entity to generate the second video. As another example, if the user 110 selects the timbre YY from the timbre list and selects the text style XX from the text style list, the terminal device 120 obtains the second audio based on the timbre selection entry and/or the text style selection entry. The second audio is formed by reading a text (e.g., text 232) having a text style XX with a timbre having a timbre YY. Then, the terminal device 120 adds the second audio and the text having the style XX to the content entity to generate the second video.

In some embodiments, the terminal device 120 may further present an adjustment panel 261, and the adjustment panel 261 may include an adjustment control 233, a text-to-speech corresponding control 263, and an edit control 264. In some examples, the terminal device 120 may present the adjustment panel 261 if detecting a trigger on a region associated with the text 232 by the user 110. Alternatively, the terminal device 120 may present the adjustment panel 261 if detecting that the user 110 triggers the setting control, which is not limited in the present disclosure.

In some embodiments, if detecting a trigger on an edit operation on the first text, the terminal device 120 presents a text edit box corresponding to the first text. The terminal device 120 receives the updated third text by the text edit box, and presents the third text overlapped on the content entity. Accordingly, the terminal device 120 removes the first audio from the content entity.

As shown in the example interface 206 in FIG. 2F, if detecting that the user 110 triggers the edit operation on the text 232, the terminal device 120 presents the text edit box corresponding to the text 232. In some examples, if detecting that the user 110 clicks the edit control 264, the terminal device 120 presents the text edit box corresponding to the text 232. Alternatively, if detecting that the user 110 clicks the region 261 associated with the text 232, the terminal device 120 may also present the text edit box corresponding to the text 232. Then, the terminal device 120 receives the updated third text (for example, the text AAAAA) by the text edit box, and presents the third text overlapped on the content entity 212. Accordingly, the terminal device 120 removes the auto dubbing A231 from the content entity 212.

In some embodiments, if detecting the text to language request for the third text, the terminal device 120 obtains the third audio corresponding to the third text. Then, the terminal device 120 adds the third audio to the content entity to obtain the third video. As shown in the example interface 206 in FIG. 2F, if the user 110 clicks the text-to-speech corresponding control 263, the terminal device 120 may convert the third text to the corresponding third audio. Then, the terminal device 120 adds the third audio and the third text to the content entity to obtain the third video.

In some examples, if the user 110 clicks the text-to-speech corresponding control 263, the terminal device 120 may use the machine learning model or randomly select a target timbre from the timbre library. Subsequently, the terminal device 120 converts the third text into the corresponding third audio with the target timbre.

In conclusion, without user input, a piece of audio may be generated based on the understanding of the content entity. Correspondingly, if the user cannot find the soundtrack which fits the theme, the terminal device may generate a matched audio based on the content entity, thereby a light, interesting and personalized audio playing manner can be provided.

FIG. 3 illustrates a flowchart of a process 300 for content generation according to some embodiments of the present disclosure. The process 300 may be implemented at the terminal device 120. The process 300 is described below with reference to FIG. 1.

At block 310, in response to an audio edit request, the terminal device 120 presents an audio edit panel comprising at least an audio generating control.

At block 320, in response to detecting a trigger on the audio generating control, the terminal device 120 obtains a first text and a first audio corresponding to the first text, at least one of the first text or the first audio being determined based on a content entity to be edited.

At block 330, the terminal device 120 adds the first text and the first audio into the content entity to obtain a first video, where the first text is presented overlapped on the content entity, and the first audio is configured to be at least a part of an audio corresponding to the first video.

In some embodiments, the first text and/or the first audio is generated based on the content entity using a machine learning model.

In some embodiments, the first audio is generated by performing text-to-speech on the first text based on a first timbre type.

In some embodiments, the first timbre type is determined by at least one of the following: determining a timbre type specified by a user as the first timbre type, or selecting the first timbre type from a timbre library randomly.

In some embodiments, a text style of the first text and/or the first timbre type of the first audio is determined based on the content entity using the machine learning model.

In some embodiments, the process 300 further includes: presenting an adjustment control in association with the first video, the adjustment control indicating adjustment to the first text and the first audio in the target content; in response to detecting a trigger on the adjustment control, obtaining a second text and a second audio for replacing the first text and the first audio, respectively, at least one of the second text or the second audio being determined based on the content entity; and adding the second text and the second audio into the content entity to obtain a second video, wherein the second text is presented overlapped on the content entity, and the second audio is configured to be at least a part of an audio corresponding to the second video.

In some embodiments, obtaining a second text and a second audio includes: in response to detecting a trigger on the adjustment control, presenting a text style selection entry and/or a timbre selection entry; receiving a selection of a second text style via the text style selection entry, and/or receiving a selection of a second timbre type via the timbre selection entry; and obtaining a second text with the second text style and the second audio with the second timbre type for replacing the first text and the first audio, respectively.

In some embodiments, the process 300 further includes: in response to a trigger on an edit operation of the first text, presenting a text edit box corresponding to the first text; receiving an updated third text via the text edit box; presenting the third text overlapped on the content entity; and removing the first audio from the content entity.

In some embodiments, the process 300 further includes: in response to detecting a text-to-speech request for the third text, obtaining a third audio corresponding to the third text; and adding the third audio into the content entity to obtain a third video.

In some embodiments, in one or more times of presentation, a visual style of the audio generating control is randomly selected from a plurality of candidate visual styles.

In some embodiments, obtaining the first text includes: sampling a part of content from the content entity; extracting, based on the part of content, first semantic information corresponding to the part of content using a semantic model; and generating the first text based on the first semantic information and prompt information, using a machine learning model.

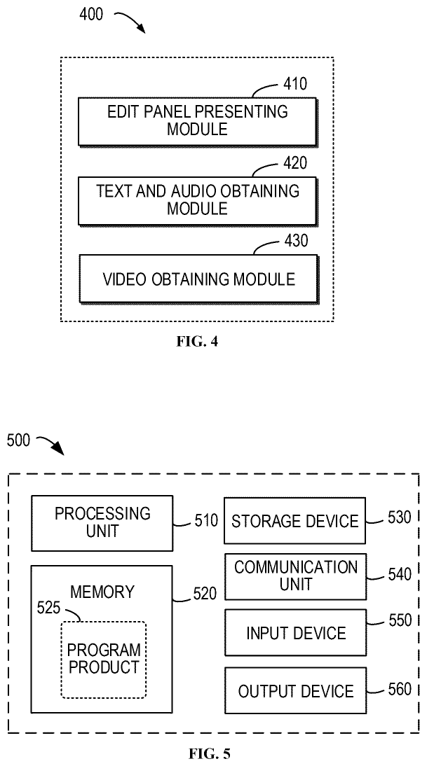

FIG. 4 illustrates a schematic structural block diagram of an apparatus 400 for content generation according to some embodiments of the present disclosure. The apparatus 400 may be implemented or included in the terminal device 120. The various modules/components in the apparatus 400 may be implemented by hardware, software, firmware, or any combination thereof.

As shown in the figure, the apparatus 400 includes an edit panel presenting module 410 configured to in response to an audio edit request, present an audio edit panel comprising at least an audio generating control. The apparatus 400 further includes a text and audio obtaining module 420 configured to in response to detecting a trigger on the audio generating control, obtain a first text and a first audio corresponding to the first text, at least one of the first text or the first audio being determined based on a content entity to be edited. The apparatus 400 further includes a video obtaining module 430 configured to add the first text and the first audio into the content entity to obtain a first video, where the first text is presented overlapped on the content entity, and the first audio is configured to be at least a part of an audio corresponding to the first video.

In some embodiments, the first text and/or the first audio is generated based on the content entity using a machine learning model.

In some embodiments, the first audio is generated by performing text-to-speech on the first text based on a first timbre type.

In some embodiments, the text and audio obtaining module 420 further includes a timbre type determining module configured to determine a timbre type specified by a user as the first timbre type, or select the first timbre type from a timbre library randomly.

In some embodiments, a text style of the first text and/or the first timbre type of the first audio is determined based on the content entity using the machine learning model.

In some embodiments, the edit panel presenting module 410 is further configured to present an adjustment control in association with the first video, the adjustment control indicating adjustment to the first text and the first audio in the target content; in response to detecting a trigger on the adjustment control, obtain a second text and a second audio for replacing the first text and the first audio, respectively, at least one of the second text or the second audio being determined based on the content entity; and add the second text and the second audio into the content entity to obtain a second video, where the second text is presented overlapped on the content entity, and the second audio is configured to be at least a part of an audio corresponding to the second video.

In some embodiments, the text and audio obtaining module 420 is further configured to in response to detecting a trigger on the adjustment control, present a text style selection entry and/or a timbre selection entry; receive a selection of a second text style via the text style selection entry, and/or receive a selection of a second timbre type via the timbre selection entry; and obtain a second text with the second text style and the second audio with the second timbre type for replacing the first text and the first audio, respectively.

In some embodiments, the text and audio obtaining module 420 is further configured to in response to a trigger on an edit operation of the first text, present a text edit box corresponding to the first text; receive an updated third text via the text edit box; present the third text overlapped on the content entity; and remove the first audio from the content entity.

In some embodiments, the video obtaining module 430 is further configured to in response to detecting a text-to-speech request for the third text, obtain a third audio corresponding to the third text; and add the third audio into the content entity to obtain a third video.

In some embodiments, in one or more times of presentation, a visual style of the audio generating control is randomly selected from a plurality of candidate visual styles.

In some embodiments, the text and audio obtaining module 420 further includes a text generation module configured to sample a part of content from the content entity; extract, based on the part of content, first semantic information corresponding to the part of content using a semantic model; and generate the first text based on the first semantic information and prompt information, using a machine learning model.

FIG. 5 illustrates a block diagram illustrating an electronic device 500 in which one or more embodiments of the present disclosure may be implemented. It should be understood that the electronic device 500 illustrated in FIG. 5 is only an example and should not constitute any limitation on the functionality and scope of the embodiments described herein. The electronic device 500 shown in FIG. 5 may be configured to implement the terminal device 120 in FIG. 1.

As shown in FIG. 5, the electronic device 500 is in the form of a general electronic device. The components of the electronic device 500 may include, but are not limited to, one or more processors or processing units 510, a memory 520, a storage device 530, one or more communication units 540, one or more input devices 550, and one or more output devices 560. The processing units 510 may be an actual or virtual processors and can execute various processes according to the programs stored in the memory 520. In a multiprocessor system, multiple processing units execute computer executable instructions in parallel to improve the parallel processing capability of the electronic device 500.

The electronic device 500 typically includes a plurality of computer storage media. Such media can be any available media that is accessible to the electronic device 500, including but not limited to volatile and non-volatile media, removable and non-removable media. The memory 520 can be volatile memory (such as registers, caches, random access memory (RAM)), nonvolatile memory (such as a read-only memory (ROM), an electrically erasable programmable read-only memory (EEPROM), a flash memory), or some combination thereof. The storage device 530 can be any removable or non-removable medium, and can include machine-readable medium, such as a flash drive, a disk, or any other medium which can be used to store information and/or data and can be accessed within the electronic device 500.

The electronic device 500 may further include additional removable/non-removable, volatile/non-volatile storage medium. Although not shown in FIG. 5, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 520 can include a computer program product 525, which comprises one or more program modules, and these program modules are configured to execute various methods or actions of the various embodiments of the present disclosure.

The communication unit 540 implements communication with other electronic devices via a communication medium. In addition, functions of components in the electronic device 500 may be implemented by a single computing cluster or multiple computing machines, and these computing machines can communicate through a communication connection. Therefore, the electronic device 500 may be operated in a networking environment using a logical connection with one or more other servers, a network personal computer (PC), or another network node.

The input device 550 may be one or more input devices, such as a mouse, a keyboard, a trackball, etc. The output device 560 may be one or more output devices, such as a display, a speaker, a printer, etc. The electronic device 500 may also communicate with one or more external devices (not shown) through the communication unit 540 as required. The external device, such as a storage device, a display device, etc., communicate with one or more devices that enable users to interact with the electronic device 500, or communicate with any device (for example, a network card, a modem, etc.) that enables the electronic device 500 communicate with one or more other electronic devices. Such communication may be executed via an input/output (I/O) interface (not shown).

According to example implements of the present disclosure, there is provided a computer-readable storage medium having computer-executable instructions stored thereon, wherein the computer-executable instructions are executed by a processor to implement the method described above. According to example implements of the present disclosure, a computer program product is further provided, the computer program product being tangibly stored on a non-transitory computer-readable medium and including computer-executable instructions, and the computer-executable instructions are executed by a processor to implement the method described above.

Various aspects of the present disclosure are described herein with reference to flowcharts and/or block diagrams of the method, the device, the apparatus and the computer program product implemented in accordance with the present disclosure. It should be understood that each block of the flowchart and/or the block diagram, and the combinations of each blocks in the flowcharts and/or block diagrams may be implemented by computer readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skilled in the art. The selection of terms used in this article aims to best explain the principles, practical application or improvement of technology in the market of each implementation, or to enable other ordinary skilled in the art to understand the various embodiments disclosed herein.

1. A method for content generation, comprising:
in response to an audio edit request, presenting an audio edit panel comprising at least an audio generating control;
in response to detecting a trigger on the audio generating control, obtaining a first text and a first audio corresponding to the first text, at least one of the first text or the first audio being determined based on a content entity to be edited; and
adding the first text and the first audio into the content entity to obtain a first video, wherein the first text is presented overlapped on the content entity, and the first audio is configured to be at least a part of an audio corresponding to the first video.

2. The method of claim 1, wherein at least one of the first text or the first audio is generated based on the content entity using a machine learning model.

3. The method of claim 1, wherein the first audio is generated by performing text-to-speech on the first text based on a first timbre type, and wherein the first timbre type is determined by at least one of the following:
determining a timbre type specified by a user as the first timbre type, or
selecting the first timbre type from a timbre library randomly.

4. The method of claim 2, wherein at least one of a text style of the first text or the first timbre type of the first audio is determined based on the content entity using the machine learning model.

5. The method of claim 1, further comprising:
presenting an adjustment control in association with the first video, the adjustment control indicating adjustment to the first text and the first audio in the content entity;
in response to detecting a trigger on the adjustment control, obtaining a second text and a second audio for replacing the first text and the first audio, respectively, at least one of the second text or the second audio being determined based on the content entity; and
adding the second text and the second audio into the content entity to obtain a second video, wherein the second text is presented overlapped on the content entity, and the second audio is configured to be at least a part of an audio corresponding to the second video.

6. The method of claim 5, wherein obtaining the second text and the second audio comprises:
in response to detecting a trigger on the adjustment control, presenting at least one of a text style selection entry or a timbre selection entry;
receiving at least one of a selection of a second text style via the text style selection entry, or a selection of a second timbre type via the timbre selection entry; and
obtaining the second text with the second text style and the second audio with the second timbre type for replacing the first text and the first audio, respectively.

7. The method of claim 1, further comprising:
in response to a trigger on an edit operation of the first text, presenting a text edit box corresponding to the first text;
receiving an updated third text via the text edit box;
presenting the third text overlapped on the content entity; and
removing the first audio from the content entity.

8. The method of claim 7, further comprising:
in response to detecting a text-to-speech request for the third text, obtaining a third audio corresponding to the third text; and
adding the third audio into the content entity to obtain a third video.

9. The method of claim 1, wherein in one or more times of presentation, a visual style of the audio generating control is randomly selected from a plurality of candidate visual styles.

10. The method of claim 1, wherein obtaining the first text comprises:
sampling a part of content from the content entity;
extracting, based on the part of content, first semantic information corresponding to the part of content using a semantic model; and
generating the first text based on the first semantic information and prompt information, using a machine learning model.

11. An electronic device, comprising:
at least one processing unit; and
at least one memory, the at least one memory being coupled to the at least one processing unit and storing instructions for execution by the at least one processing unit, the instructions, when executed by the at least one processing unit, causing the electronic device to perform acts comprising:
in response to an audio edit request, presenting an audio edit panel comprising at least an audio generating control;
in response to detecting a trigger on the audio generating control, obtaining a first text and a first audio corresponding to the first text, at least one of the first text or the first audio being determined based on a content entity to be edited; and
adding the first text and the first audio into the content entity to obtain a first video, wherein the first text is presented overlapped on the content entity, and the first audio is configured to be at least a part of an audio corresponding to the first video.

12. The electronic device of claim 11, wherein at least one of the first text or the first audio is generated based on the content entity using a machine learning model.

13. The electronic device of claim 11, wherein the first audio is generated by performing text-to-speech on the first text based on a first timbre type, and wherein the first timbre type is determined by at least one of the following:
determining a timbre type specified by a user as the first timbre type, or
selecting the first timbre type from a timbre library randomly.

14. The electronic device of claim 12, wherein at least one of a text style of the first text or the first timbre type of the first audio is determined based on the content entity using the machine learning model.

15. The electronic device of claim 11, wherein the acts further comprise:
presenting an adjustment control in association with the first video, the adjustment control indicating adjustment to the first text and the first audio in the content entity;
in response to detecting a trigger on the adjustment control, obtaining a second text and a second audio for replacing the first text and the first audio, respectively, at least one of the second text or the second audio being determined based on the content entity; and
adding the second text and the second audio into the content entity to obtain a second video, wherein the second text is presented overlapped on the content entity, and the second audio is configured to be at least a part of an audio corresponding to the second video.

16. The electronic device of claim 15, wherein obtaining the second text and the second audio comprises:
in response to detecting a trigger on the adjustment control, presenting at least one of a text style selection entry or a timbre selection entry;
receiving at least one of a selection of a second text style via the text style selection entry, or a selection of a second timbre type via the timbre selection entry; and
obtaining the second text with the second text style and the second audio with the second timbre type for replacing the first text and the first audio, respectively.

17. The electronic device of claim 11, wherein the acts further comprise:
in response to a trigger on an edit operation of the first text, presenting a text edit box corresponding to the first text;
receiving an updated third text via the text edit box;
presenting the third text overlapped on the content entity; and
removing the first audio from the content entity.

18. The electronic device of claim 17, wherein the acts further comprise:
in response to detecting a text-to-speech request for the third text, obtaining a third audio corresponding to the third text; and
adding the third audio into the content entity to obtain a third video.

19. The electronic device of claim 11, wherein in one or more times of presentation, a visual style of the audio generating control is randomly selected from a plurality of candidate visual styles.

20. A non-transitory computer-readable storage medium having a computer program stored thereon, the computer program being executable by a processor to perform acts comprising:
in response to an audio edit request, presenting an audio edit panel comprising at least an audio generating control;
in response to detecting a trigger on the audio generating control, obtaining a first text and a first audio corresponding to the first text, at least one of the first text or the first audio being determined based on a content entity to be edited; and
adding the first text and the first audio into the content entity to obtain a first video, wherein the first text is presented overlapped on the content entity, and the first audio is configured to be at least a part of an audio corresponding to the first video.
